(19) United States
(12) Patent Application Publication
(10) Pub. No.: US 2008/0318576 A1
(43) Pub. Date: Dec. 25, 2008

(54) Handover Between Wireless Cellular Network and Private Network in Wireless Communications

(76) Inventors: Tricci So, San Diego, CA (US); Jerry Pak Lup Chow, San Diego, CA (US)

Correspondence Address: FISH & RICHARDSON, PC, P.O. BOX 1022, MINNEAPOLIS, MN, 55440-1022, US

(21) Appl. No.: 12/143,728

(22) Filed: Jun. 20, 2008

Related U.S. Application Data
(60) Provisional application No. 60/945,204, filed on Jun. 20, 2007.

(51) Int. Cl. H04Q 7/20

(52) U.S. Cl. 455/436; 455/444; 455/434

(57) ABSTRACT

Techniques and systems for performing handover of a mobile station between a cellular wireless network and a private cell or private network.

### PRIORITY CLAIM AND RELATED PATENT APPLICATION

This application claims the benefit of U.S. Provisional Application No. 60/945,204 entitled “Handover from Public Macro-Cell to Private Cell/Network within Same or in Adjacent Coverage Area” and filed on Jun. 20, 2007. The entire disclosure of the above patent application is incorporated by reference as part of the specification of this application.

### BACKGROUND

This application relates to wireless communication systems and techniques.

Wireless communication systems use electromagnetic waves to communicate with fixed and mobile wireless communication devices, e.g., mobile wireless phones and laptop computers with wireless communication cards, that are located within cells of coverage areas of the systems. Base stations are spatially distributed to provide radio coverage in a geographic service area that is divided into radio cells. In operation, a base station transmits information to a wireless subscriber station (SS) such as a mobile station (MS) via BS-generated downlink (DL) radio signals. A MS at a particular cell transmits information to its serving base station for that particular cell via uplink (UL) radio signals. The base stations can include directional antennas to further divide each cell into different cell sectors where each antenna covers one sector. This sectorization of a cell increases the communication capacity.

In some wireless communication networks, the base stations may be configured to in a multi-tier configuration. For example, a base station may placed in a radio cell of another base station to provide radio coverage of a small section of the radio cell. In this case, the large cell can be considered as a macrocell because another base station is located within the macrocell region and the smaller cell inside the macrocell can be considered a microcell. This macrocell-microcell configuration can expand the radio coverage of the network and can increase the radio frequency bands and thus the communication capacity of the network. One macrocell may include one or more microcells depending on the needs for radio coverage in that macrocell. This tiered base station configuration can further include picocells each providing radio coverage in a small region within a microcell.

### SUMMARY

This application includes techniques and systems for performing handover of a mobile station between a cellular wireless network and a private cell or private network. In one implementation, a wireless communication system includes a cellular wireless network comprising a plurality of cells with base stations to provide wireless access to subscribed mobile stations, the cellular wireless network comprising a list of neighboring cells for cells in the cellular wireless network; a private wireless network comprising one or more private cells to provide wireless access to a subset of the subscribed mobile stations in the cellular wireless network; a mechanism to obtain mapping information between a serving cell in the cellular wireless network for a mobile station and radio cells in the private wireless network to which the mobile station is granted access; and a mechanism to select radio cells in the one or more private wireless networks as candidate radio cells for handover of the mobile station from the serving cell in the cellular wireless network to one of the selected radio cells of the private wireless network.

In another implementation, a wireless communication system includes a cellular wireless network comprising a plurality of cells with base stations to provide wireless access to subscribed mobile stations, the cellular wireless network comprising a list of neighboring cells for cells in the cellular wireless network; a private wireless network comprising one or more private cells to provide wireless access to a subset of the subscribed mobile stations in the cellular wireless network; a mechanism to obtain mapping information between a serving cell in the cellular wireless network for a mobile station and radio cells in the private wireless network to which the mobile station is granted access; a first handover mechanism to perform a handover from the serving cell in the cellular wireless network to another cell in the cellular wireless network based on the list of neighboring cells for cells in the cellular wireless network; and a second handover mechanism to perform a handover from the serving cell in the cellular wireless network to a cell in the one or more private wireless networks based on the information on access to one or more private wireless networks granted to the mobile station that is being served by the cell of the cellular wireless network in the mobile station, without relying on the list of neighboring cells for cells in the cellular wireless network.

In yet another implementation, a method for handling handover between a cellular wireless network and a private wireless network includes providing the cellular wireless network with information on access to one or more private wireless networks granted to a mobile station that is subscribed to the cellular wireless network and is being served by a cell of the cellular wireless network. Each of the one or more private wireless networks provides wireless access for a subset of all users subscribed to the cellular wireless network. This method includes operating the cellular wireless network to obtain mapping information between the serving cell in the cellular wireless network and radio cells in the one or more private wireless networks to which the mobile station is granted access; and selecting radio cells in the one or more private wireless networks as candidate radio cells for handover of the mobile station from the serving cell in the cellular wireless network to one of the selected radio cells of the one or more private wireless networks.

This and other implementations and features are described in greater detail in the attached drawings, the description and the claims

### BRIEF DESCRIPTION OF DRAWINGS

FIG. 1 illustrates an example of hierarchical cells in a wireless network deployment scenario.

FIG. 2 illustrates an example of a flow of operations for handover from a macrocell to a private cell.

### DETAILED DESCRIPTION

Various private wireless networks, separate from public wireless networks for providing mobile communication services to the general public, are becoming popular. Such private networks provide radio cells that cover selected service areas such as a home, one or more offices, and a corporate or university campus and can provide wireless services in conjunction with public wireless networks. This combination of public and provide networks can be used to provide a higher quality mobility environment for the user within areas in which the user wishes to maintain communications while on the move. Handovers between a macro-cellular network and smaller and localized cells of private networks are needed to provide continuous communications for users that use both the macro-cellular network and a private wireless network. The radio coverage organization that needs to be considered for these types of handovers can be different than in traditional wireless networks. Instead of cells predominantly organized to provide radio coverage to adjacent areas, there are now potentially many smaller cells within the coverage area of the macro-cell. In addition, access to the smaller underlying cell or network is typically restricted to a small subset of the users of the macro-cellular network.

In the examples described below, a cell represents a radio coverage area that may require a handover to maintain communications continuity as a mobile station moves into the radio coverage area. For example, a cell can include an omni-cell or sectors of a sectorized cell in a real-world deployment and operations and processing by a cell are performed by a base station associated with that cell. A macrocell is a cell in a wireless network to which the entire population of users of the wireless network has the right and privileges to access. A private cell or a private network in the following examples has restricted access for only selected users and examples for such private cells or private networks include femto cells and home wireless access points. Such a private cell or a private network has certain characteristics that are different from those of traditional wireless networks. Thus, in private cells and networks such as the home-area, office-area and campus cells or networks, techniques to support handover from one cell to another used in a microcell network can be inefficient in handling handover between a macro cell network and a private network.

For example, one feature in some traditional handover mechanisms that do not scale well to support handover between a macro cell network and a private network is the use of neighbor lists that are considered generally applicable to all users in the coverage area. More specifically, there can be a large potentially large number of the underlying cells and the neighbor list applicable to the overlying macro-cell can become large and broadcasting of this large neighbor list to assist mobile stations to determine potential target cells may consume significant over-the-air capacity. Notably, a underlying cell may admit only a small subset of users and prohibit access by other users, including and advertising all such cells in the general neighbor list makes determination of a target cell for handover by all mobile stations inefficient because non-applicable entries are received and processed and there is no mechanism for the MS to determine which neighbors are applicable to it for the handover.

For another example, various macrocell mobile networks use autonomous MS scanning to determine the best prospective candidate cell(s) for handover. Since a cell in the list may admit only a small subset of users and prohibit access by other users, the MS may be forced to evaluate and propose potential handover target cells to which it cannot successfully have access when the MS is not provided with information on the subset membership and accessibility of cells.

This application describes, examples and implementations of techniques and network designs that provide efficient handover between a macro cell network and a private network. In general, the overall system interactions described here between the private cell/network and the macro cell network applies also between the private cell/network and pico or micro cell network. Therefore, whenever the reference of the macro cell described herein shall also apply to the picocells and microcells.

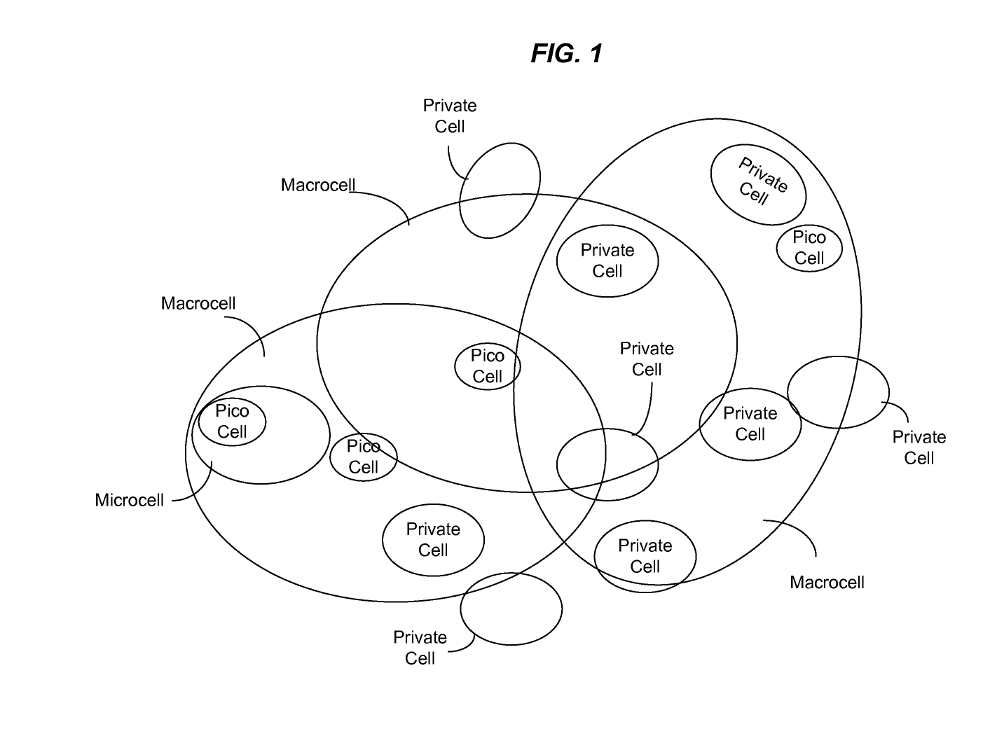

FIG. 1 illustrates an example of hierarchical cells in a wireless network deployment scenario. Multiple macrocells are provided in the service coverage region for access by all subscribed users. Microcells and picocells that are accessible by all subscribed users are also illustrated. Private cells and networks in FIG. 1 are different from macrocells, microcells and picocells and are private in that only a subset of subscribed users for the macro-cellular network can access. Because access is limited, the control of which users can be allowed access to private cells and networks is administered separately from the subscription for access to the macro-cellular network. In one implementation, for example, the access control in the underlying cell or network can be done by using an Access Control List (ACL) to determine the right for a user device to access the cell or network based on a discernable identifier, such as a MAC address, in protocol messages sent by the device. In another implementation, the access control can be a full authentication and authorization of both device and user.

In the examples in this application, it is assumed that the administrative relationship between the underlying private cell or network and the macro-cellular network includes the following characteristics. First, there is a business arrangement whereby the users accessing the private underlying cell or network has subscription to the macro-cellular network for wireless access when service cannot be provided from the private cell or network (i.e. moving out of the coverage area of the underlying cell or network). One example for this type of relationship is that the underlying private cell or network and the macro-cellular network can be operated by the same business entity. Second, there is a trust relationship between the administrative entity of the underlying private cell or network and the operator of the macro-cellular network such that any addition of users granted access to the underlying private cell or network is communicated to the administrative system of the macro-cellular network and the user is identified by an identifier that can be associated by the macro-cellular network to an authenticated user and device. Third, the macro-cellular network has knowledge of the geographic location and coverage area of a underlying private cell and network. With this knowledge, the macro-cellular network can map the location of the private cell or the location of one or more border cells of a private network to the coverage area of the macro-cells of the macrocell cellular network.

The present handover techniques can be used to augment and supplement existing mechanisms of neighbor lists and autonomous MS scanning for potential handover targets with other mechanisms to provide efficient, effective and fast determination of a private cell or network as a potential handover while the MS is being served by a respective overlying macro-cell in the macrocell cellular network. In the macro-cell, the neighbor list is maintained for other adjoining macro-cells but no neighbor list entries are added for the underlying private cells, or one or more cells of a private wireless network that are considered to be border cells between this private network and the macro-cell network. Notably, relevant operational information for each MS being served is kept at the serving macro-cell to facilitate the efficient, effective and fast determination of an underlying cell as a potential handover target in a private cell or network.

The above relevant operational information for each mobile station kept at the serving macrocell includes the identity of underlying private cells within the coverage area of the macro-cell that the user of the MS has permission to access. With this information, the macro-cell can use the network-initiated scanning to instruct the MS to take and report measurements on the identified underlying private cells for which the MS has permission to access. Based on these measurement reports, the macro-cell can determine when to instruct the MS to perform a handover to a permitted underlying private cell based on a handover policy. One example for such policy is to always force a handover to the permitted underlying private cell as long as the estimated service is deemed to be acceptable in the underlying cell. Another policy may be to use the foregoing policy as a base policy amended with the exception if the speed of the MS is determined to be greater than a certain limit such as 10 miles per hour as an example. Many policy variations may exist and can fit into this decision framework. The MS can be operated based on existing mechanisms defined by the technology or by other means, such as some manual indication by the user and the MS may initiate handover to the permitted underlying private cell. The macro-cell network can leverage the operational information described above to support the MS's decision for the appropriate handoff target private cell For example, the user may depress a key or otherwise execute a command of the MS device to force the macro-to-private cell handover. For another example, the MS detects that the certain handover decision threshold has been reached and then initiates the handover to a potential target private cell.

In one implementation, a handover mechanism can be implemented to include the following aspects. First, a macro-cellular network is configured to learn and obtain the information that a user MS has been granted access to an underlying private cell or network, to maintain this information for future use, and distributes such information as needed to internal parts of the marcrocell network for immediate use. Second a mechanism for determining the applicable underlying private cells for each user MS being served by a macro-cell is provided. Third, a mechanism is provided to obtain measurements of the underlying private cells applicable to a user MS for evaluation of a potential handover target without the need to include such cells in the neighbor cell list.

An example for obtaining macro-cell knowledge of the private cell membership is now described. It is presumed that by default an underlying private cell/network does not allow any general users to access its network and that a method is provided locally at the private cell/network to provision access privileges for new users and devices. As an example for implementing such a method, an Access Control List (ACL) may be provided whereby the MAC addresses or other kind of unique identifiers of wireless communications devices associated with authorized users are entered. As another example for implementing such a method, secure private information associated with each authorized user that is compatible with a secure authentication and authorization protocol supported by the wireless technology may be entered into an Administration, Authentication and Authorization (AAA) database.

Under an existing trust relationship between the administrative entity of the underlying private cell/network and the macro-cellular network, whenever a new user is granted access to the private cell/network by being provisioned with access privileges, the private cell/network provides the macro-cellular network with this information that associates permission for access to the specific private cell/network (as identified by an agreed-to cell or network identifier) by a specific user as identified by an agreed-to user identifier (which may be the identifier of a device associated with the user). This information exchange can occur via various means. For example, this exchange can be a person to person communications. For another example, this exchange can occur autonomously via a signaling protocol between the private cell/network and the macro-cellular network.

In operation, the macro-cellular network is kept up-to-date as to the current list of users each being granted access to a particular private cell/network. Using this information and the knowledge that the macro-cellular network has on the geographic location and coverage area of the specific underlying private cell or private network, the macro-cellular network can be operated to associate the user with the specific private cell, or border cells of the private network, and the specific macro-cells within its network that can be involved in handovers from the macro-cellular network to the private cell/network.

In response to a change to the list of users granted access to a private cell/network, the macrocell network can be operated to include one entry for a user who is newly granted for access to a private cell or network into the macro-cellular networks operational data associated with the user and this entry includes the cell ID for the private cell or each of the one or more border cells in a private network, and Macro Cell IDs for macrocells, if any, from which the user may perform handover to the Private Cell or to which the user may perform handover from the Private Cell. When there are no macrocells suitable for handover with a private cell or private network, the entry for the Macro Cell ID can be set zero to indicate that mobility service cannot be provided from the macro-cellular network to this particular Private Cell.

In this case, nomadic service may be provided to the user. Any new such Private Cell entries are incorporated into the user's macro-cellular subscriber operational information. In one implementation, this information can be maintained as part of the subscriber profile information and stored at the Home AAA (H-AAA) function from where the full set of Private Cell ID information (along with other necessary configuration and operational information associated with the user) come into effect each time the user is successfully authenticated for service. If the user is already active in the macro-cellular network and the macro-cell at which the user is currently being served is one of the cells from which handover can be performed to the Private Cell, the new Private Cell ID is provided to the serving macro-cell to be added as a potential Private-Cell handover target for the user. This information may also be added to the handover context information that will be transferred to the target cell if the target is a macro-cell.

Various mechanisms can be provided for a macro-cell to obtain the applicable Private Cell information for a user when the user is served by the macro-cell. In one example for such mechanisms, the macro-cell queries a more centralized location/function in the network for any such information for the user. This more centralized location/function may be the H-AAA itself or private cell gateway to allow the local agent of the private cell at the current serving access network to provide such information to support the handoff operation for the appropriate user.

In another example for such mechanisms, when the user enters the macro-cell on handover, the full set of Private Cell IDs and their associated macro-cells can be directed to the macro-cell as part of the handoff context information from the previous serving macro-cell. From this data received b the macrocell, the macrocell can determine whether the user has any Private Cells within the macro-cell's coverage area to which the user has access privileges. The H-AAA or the private cell gateway can be operated to push the access privilege information to the local agent of the private cell at the access network. This operation can be used to ensure that the handoff context is kept up-to-date as the private cell/network may add or delete new user to access the private cell/network while the user has been active with the current serving access network. Consequently, the handoff context of the corresponding user will be updated with the access privilege to the private cell.

Based on the above updated information on the private cells or private network, the handover target can be selected from the private cells or networks identified in the above private cell mapping for handover from a Macro-cell to a Private Cell Based on the information acquisition, processing, and dissemination process described in this specification, a macro-cell knows that a user currently being served by the macrocell has permission to access one or more Private Cells to which the macro-cell is able to support handover. An example for a procedure between the macro-cell and the user's MS in order to allow these Private Cells as potential handover targets without the necessary support by the advertised neighboring cell list.

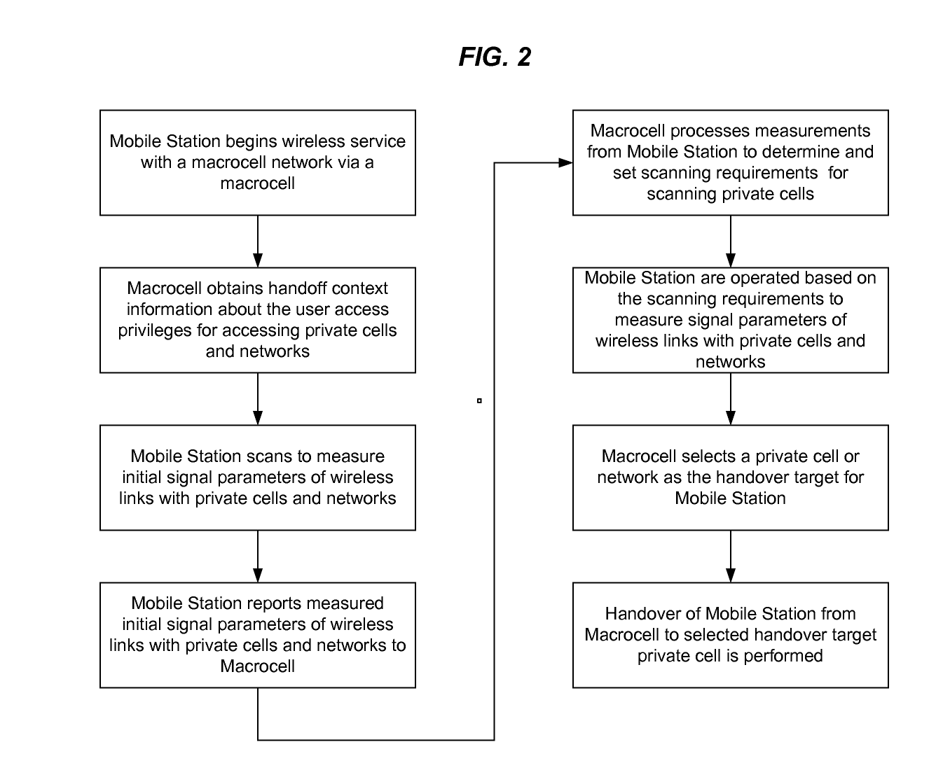

FIG. 2 illustrates a flow of operations in this procedure.

1. A user MS begins the wireless service from the access network via a macro-cell. This can occur via a number of ways including 1) a handover from another macro-cell or from an underlying Private Cell, 2) a re-entry or re-activation into the network from a MS idle state, or 3) from a full entry activation into the network on the MS's first access attempt or after the MS was previously de-activated (such by the MS having been powered off) and is then re-activated.

2. On completion of the network entry or re-entry procedure, the macro-cell obtains handoff context information about the user's access privileges to all Private Cells to which the macrocell can support handover. There are a number of methods whereby this information is obtained and the particular implementation may choose to use one or more of these methods based on system performance, cost, and complexity considerations.

3. If the Private_Cell_Scan_List for the user is not empty, then MS is instructed by the macro-cell using network-initiated target cell scanning procedures provided by the wireless technology to report an initial set of measurement for each of the Private Cells in the list. These measurements aids the evaluation of relative likelihood that one of the Private Cells is more likely a handover target than others. These measurements can include, for example, RSSI (Received Signal Strength Indication) and CINR (Carrier to Interference and Noise Ratio).

Alternatively, the Private_Cell_Scan_List can be used to build a set of private neighbor cell information that is installed in the MS. Each MS which has access privileges to one or more private cell/networks can have its own set of private neighbor cell information—that is, as opposed to the general macro-cell neighbor list, this information is not available to other MSs. The information contained in each entry of this private cell neighbor list may be similar to the information in the general macro-cell neighbor list to provide sufficient information for the MS to perform scanning (such as carrier frequency and basic cell identification), for target handover selection (such as signal quality thresholds), and to support fast handover (such as critical physical and MAC layer communications parameters). After the mobile station initiates the scan of the private cells on the list, the mobile station can process the measurements of the signal qualities with different private cells and select one or more candidates for the handover target private cell. Next, the mobile station communicates the selected one or more candidates to the base station of the macrocell and the macrocell can evaluate this information and make a final selection of the target private cell for the handover.

In addition, the private cell neighbor information can contain handover/cell-selection policy information such as the priority for selection of a private cell versus other private cells or versus the macro-cell. The MS uses this private cell neighbor information to augment the general macro-cell neighbor information that it receives normally as broadcast information from the macro-cell. The private cell neighbor information can be provisioned statically or semi-statically in the MS if the information for all private cells to which the MS has access privileges are provided where the information may only change when the MS gains or loses access privileges to private cells or when any private cell neighbor information is changed.

The private cell neighbor information can also be maintained dynamically when only a subset of the private cell neighbor information, such as those which are within the coverage area of a group of one or more macro-cells, are provided to the MS at any time and this corresponds to the scenario where Private_Cell_Support_Zones are defined. Such dynamic updating can occur via signaling from macro-cell to MS when MS acquires service from a particular macro-cell either via entry or re-entry into the network at or via handover to the particular macro-cell, and such signaling is only necessary if the MS does not already have the appropriate set of private cell neighbor information, where the appropriateness of such a set may be identified by a code (e.g. Private_Cell_Support_Zone_ID). When private cell neighbor information is installed in the MS, it may proceed with scanning for private cell neighbors without being instructed explicitly by the macro-cell and may report back scan measurement results or propose handover candidates to the macro-cell based on particular configurations in the neighbor information which is similar to its operation based on the general macro-cell neighbor list.

4. The MS performs the requested measurements when it is not otherwise busy supporting communications active for the user. At least once when all requested measurements are complete or also when requested intermediate results are available, such measurements are reported back to the macro-cell.

5. The macro-cell processes the measurement results and determines scanning requirements for each Private Cell in the Private_Cell_Scan_List according to the relative likelihood as a potential handover target if this is apparent. If not, the scanning settings can be set the same for all Private Cells.

6. After collecting sufficient measurements to gain confidence of validity and stability of wireless links with private cells and networks on the list and if the MS is not in a handover holdoff period that may be in effect to prevent excessive handover ping-ponging, the macrocell evaluates the results for all Private Cells in the Private_Cell_Scan_List to determine if any of the targets meets configured handover target selection criteria, e.g., such RSSI is greater than a RSSI_Threshold and CINR is greater than a CINR_Threshold. If MS is in a handover holdoff period, the first evaluation occurs upon expiry of the holdoff period.

7. If one or more Private Cells meet their respective target selection criteria, the one that should provide best service can be selected as the handover candidate which can be the Private Cell for which the highest CINR is measured. The handover target selection can also be conditioned by policy-based criteria, such as a Private Cell designated as a Home Private Cell having priority in selection versus one without this designation.

8. Next, the handover from the serving macrocell to the selected handover target private cell can be performed based on a network-initiated handover as defined by the wireless technology.

The above handover processes for handover of a MS from a macrocell to a private cell or network is based network initiated handover processes. Alternatively, the MS can also leverage the procedures and information collected as described above to conduct the MS initiated handover procedures towards the target private cell.

In the above example for the handover process, the serving macrocell can obtain the handoff context information about the user access privileges for accessing private cells and networks via various techniques. Several examples are described below.

In an example where the user MS has begun service at the serving macro-cell as a result of completion of handover, the full set of mapping of macro-cells can be transferred from the prior serving macrocell to the current serving macrocell as part of the MS's Handover Context information. This information can support MS's handover decision to each Private Cell which is the neighbor of the current serving BS and the user of the corresponding MS has access privileges to the base station of the new target private cell that the MS can handover to. The current serving macro-cell processes the list of Private Cell(s) to macro-cell(s) mapping information and determines to which of these Private Cells which are the neighbors of the current serving macro-cell, if any, the user & MS can potentially perform handover. In addition, the list of the potential Private Cells that the MS has the access privilege may be prioritized to optimize the network-initiated scanning and/or the network-initiated handover decisions. If there is not a single suitable private cell or network, then the remainder of this Private-Cell specific handover target selection procedure does not take effect (i.e. this procedure is exited). If one or more suitable target private cells or networks are present, then the identities of these Private Cells are inserted into a new list, Private_Cell_Scan_List, as possible Private Cell handover targets. If these Private Cells have been prioritized, the list shall be organized according to the priorities that were assigned.

If the procedure above is deemed to involve too many Private Cell entries (i.e. the user has been granted access to many Private Cells) that can cause the MS's Handover Context to become excessively large if the information for all these Private Cells were included, the macro-cells can be organized into subsets called, Private_Cell_Support_Zones, which are identified by a Private_Cell_Support_Zone_ID. Each macro-cell is assigned to a specific Private_Cell_Support_Zone for a given user, and therefore, has associated with it a Private_Cell_Support_Zone_ID. Some pre-processing of the full set of Private Cell to macro-cell mapping information for the user & MS has been done elsewhere within the macro-cellular network to divide this large full set into a reasonable number of subsets of smaller size based on the partitioning of all macro-cells in the macro-cellular network into reasonable Private_Cell_Support_Zones for a given user. These subsets of mapping data are cached at some location in the macro-cellular network from which individual macro-cells can query for the subset belonging to a particular Private_Cell_Support_Zone.

In operation during handover, the Private_Cell_Support_Zone_ID, if assigned, is provided by the potential target cell to the current serving macro-cell during the handover preparation procedure. if the handover target belongs to the same Private_Cell_Support_Zone as determined by having been assigned the same Private_Cell_Support_Zone_ID, the current serving macro-cell includes the subset of Private Cell to macro-cell mapping information that it has and passes it to the target macro-cell as part of the MS's Handover Context information and the procedure can be completed based what is described above. If the handover target does not belong to the same Private_Cell_Support_Zone as determined by having been assigned different Private_Cell_Support_Zone_IDs, the current serving macro-cell does not include any Private Cell to macro-cell mapping information and therefore, upon completion of handover, the procedure continues as described below.

If the macro-cell does not have any Private Cell to macro-cell mapping information after the user MS completes the network entry or re-entry, the macrocell proceeds to obtain the mapping information from some more centralized location/function within the macro-cell network. In this type of scenario, the procedure can proceed in various ways. Two example are described below.

In the first example where the procedure implementation requires that the macro-cell retrieves the Private Cell to macro-cell mapping information from the more centralized location/function, even on completion of handovers meaning that this mapping information is never included in the Handover Context information, then the follow two alternative procedures or other procedures can be applied.

In the first procedure, some processing takes place or pre-processing has taken place at the more centralized location/function such that the macro-cell is provided only with the list of Private Cells to which the user has access privileges and to which the macro-cell can support handover. If no Private Cells are provided to the macro-cell in response to query from macro-cell to the more centralized location/function, then the remainder of this Private-Cell specific handover target selection procedure does not take effect (i.e. this procedure is exited). If one or more is provided, then the identities of these Private Cells are inserted into a new list, Private_Cell_Scan_List, as possible Private Cell handover targets.

In the second procedure, the full set of the Private Cell to macro-cell mapping information for the user is passed to the macro-cell and the macro-cell itself processes and retains for use the subset of Private Cells to which the user has access privileges and to which the macro-cell can support handover. The processing of this full set of mapping information can be performed as described above.

In the second example where the procedure implementation intends to include the Private Cell to macro-cell mapping information as part of the Handover Context information, several mechanisms can be provided. In one example where the macro-cell is not assigned a Private_Cell_Support_Zone_ID, then the full set of Private Cell to macro-cell mapping information for the user is obtained from the more centralized location/function and is retained as part of the MS's Handover Context information (either at the macro-cell or at a more centralized location/function). In another example where the macro-cell has been assigned a Private_Cell_Support_Zone_ID, then only the subset of Private Cell to macro-cell mapping information for the user in the Private_Cell_Support_Zone is obtained by the macro-cell from the more centralized location/function and is retained as part of the MS's Handover Context information (either at the macro-cell or at a more centralized location/function).

A user MS being served by a private cell or network can also be handed over a macrocell or other cell in a macrocell cellular network. As part of this handover process, the information on the neighboring macrocells of the serving private cell is obtained. In one implementation, the set of macro-cells that are potential handover targets from a specific Private Cell can be provided to that cell by the macro-cellular network the first time that this Private Cell registers a user with permitted access or from time to time as required if the potential macro-cell handover target candidates change (e.g. perhaps due to some radio coverage reconfiguration of the macro-cellular network within the vicinity). As such, the Private Cell uses this information to build its neighbor list of handover target candidates which is used in the traditional fashion to evaluate neighboring cells for suitability as handover targets and to trigger handover to one of these macro-cell targets when the appropriate condition is met.

Based on the above neighbor list, the handover target selection process can follow a MS-driven process, such as MS-initiated scanning, to select a macrocell to handover the MS. For example, a MS-initiated macrocell-to-macrocell handover procedure can be used where the setting values of the parameters of the handover target selection criteria are selected to condition the handover to some policy-based behavior, such as biasing service to the Private Cell unless quality of service becomes unacceptable versus using a best quality of Service condition.

The above examples illustrate a number of features for efficiently handling handover between a macro cell network and a private network. These features include sharing of list of valid users between the macro cell network and a private cell network to provide mapping between the macro cell and the corresponding neighbor private cells, and supporting dynamic update of the mapping between the macro cell and the corresponding neighbor private cells; adding new private cell to macro-cell mapping information to the subscriber information; methods to provide the mapping information to a macro-cell and to use the macro-cell to determine the Private Cells for the user that are applicable to the macro-cell; using the network-initiated scanning of Private Cells and the Private Cell to Macro-cell mapping information to determine suitability as handover targets, thus eliminating the need to add the Private Cells to the advertised neighbor cell list; and processing the measurements and applying any policy-based criteria as part of handover target selection. Various techniques for providing the mapping information to a macro-cell can be used in various implementation, including sending a macro-cell query to a more centralized location/function with only those Private Cells valid for the user and applicable to the macro-cell; operating a macro-cell to extract the Private Cells in this list applicable to the macrocell from all Private Cell to Macro-cell mapping information; providing the full set of Private Cell to Macro-cell mapping information as part of the Handover Context information from the previous serving macro-cell; providing a defined subset of the Private Cell to Macro-cell mapping information, as partitioned by Private_Cell_Support_Zone and transferred as part of Handover Context information from the previous serving macro-cell.

The handover techniques for handover between the private cells and the macrocells can be implemented to be compatible with handover processes between different macrocells. For example, one example of a wireless communication system that implements the present handover techniques can include a cellular wireless network comprising a plurality of cells with base stations to provide wireless access to subscribed mobile stations, the cellular wireless network comprising a list of neighboring cells for cells in the cellular wireless network; a private wireless network comprising one or more private cells to provide wireless access to a subset of the subscribed mobile stations in the cellular wireless network; a mechanism to obtain mapping information between a serving cell in the cellular wireless network for a mobile station and radio cells in the private wireless network to which the mobile station is granted access; a first handover mechanism to perform a handover from the serving cell in the cellular wireless network to another cell in the cellular wireless network based on the list of neighboring cells for cells in the cellular wireless network; and a second handover mechanism to perform a handover from the serving cell in the cellular wireless network to a cell in the one or more private wireless networks based on the information on access to one or more private wireless networks granted to the mobile station that is being served by the cell of the cellular wireless network in the mobile station, without relying on the list of neighboring cells for cells in the cellular wireless network.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications and enhancements to the described examples and implementations, and other implementations can be made based on what is disclosed.

What is claimed is:

1. A method for handling handover between a cellular wireless network and a private wireless network, comprising:
providing the cellular wireless network with information on access to one or more private wireless networks granted to a mobile station that is subscribed to the cellular wireless network and is being served by a cell of the cellular wireless network, wherein each of the one or more private wireless networks provides wireless access for a subset of all users subscribed to the cellular wireless network;
operating the cellular wireless network to obtain mapping information between the serving cell in the cellular wireless network and radio cells in the one or more private wireless networks to which the mobile station is granted access; and
selecting radio cells in the one or more private wireless networks as candidate radio cells for handover of the mobile station from the serving cell in the cellular wireless network to one of the selected radio cells of the one or more private wireless networks.

2. The method as in claim 1, comprising:
applying a selection condition to select one radio cell from the candidate radio cells as a target radio cell for the handover; and
performing handover of the mobile station from the cellular wireless network to the selected one target radio cell.

3. The method as in claim 2, comprising:
measuring signal qualities of wireless links between the mobile station and radio cells in the one or more private wireless networks to which the mobile station has access and that are adjacent to the serving cell of the cellular wireless network; and
using the measured signal qualities to select the candidate radio cells for handover of the mobile station.

4. The method as in claim 3, wherein:
a received signal strength and a carrier to interference and noise ratio are measured to represent a signal quality of a wireless link between the mobile station and a radio cell in the one or more private wireless networks.

5. The method as in claim 1, wherein:
the information on access to one or more private wireless networks granted to the mobile station that is being served by the cell of the cellular wireless network comprises a list of cells in the one or more private wireless networks that are neighbors of the serving cell for the mobile station in the cellular wireless network.

6. The method as in claim 5, comprising:
providing the list of cells in the one or more private wireless networks that are neighbors of the serving cell for the mobile station in the cellular wireless network as part of a handover context information package for the mobile station which previously handovers from a prior serving cell in the cellular wireless network to the serving cell that currently serves the mobile station.

7. The method as in claim 5, wherein:
operating the serving cell to obtain the list of cells in the one or more private wireless networks that are neighbors of the serving cell for the mobile station in the cellular wireless network from another entity in the cellular wireless network.

8. The method as in claim 5, comprising:
accessing a base station of the serving cell to obtain the list of cells in the one or more private wireless networks that are neighbors of the serving cell for the mobile station in the cellular wireless network from another entity in the cellular wireless network.

9. The method as in claim 8, comprising:
when the base station of the serving cell does not have any entry in the list of cells in the one or more private wireless networks that are neighbors of the serving cell for the mobile station in the cellular wireless network, accessing another entity in the cellular wireless network for the list.

10. The method as in claim 1, comprising:
storing in the mobile station a list of cells in the one or more private wireless networks that are neighbors of the serving cell for the mobile station in the cellular wireless network.

11. The method as in claim 10, comprising:
operating the mobile station to initiate a scanning of cells on the list of cells in the one or more private wireless networks that are neighbors of the serving cell for the mobile station in the cellular wireless network to determine signal qualities of wireless links with cells in the list.

12. The method as in claim 11, comprising:
operating the mobile station to evaluate measurements of signal qualities of the wireless links with cells on the list and to select one or more candidates for a target radio cell in the list for the handover.

13. The method as in claim 12, comprising:
operating the mobile station to communicate to the serving cell in the cellular wireless network the selected one or more candidates for the target radio cell in the list for the handover.

14. The method as in claim 10, comprising:
storing a handover policy in the mobile station.

15. The method as in claim 1, comprising:
providing the cellular wireless network with a list of neighboring cells for cells in the cellular wireless network that is separate from the information on access to one or more private wireless networks granted to the mobile station that is being served by the cell of the cellular wireless network in the mobile station;
performing a handover from the serving cell in the cellular wireless network to another cell in the cellular wireless network based on the list of neighboring cells for cells in the cellular wireless network; and
performing a handover from the serving cell in the cellular wireless network to a cell in the one or more private wireless networks based on the information on access to one or more private wireless networks granted to the mobile station that is being served by the cell of the cellular wireless network in the mobile station, without relying on the list of neighboring cells for cells in the cellular wireless network.

16. A wireless communication system, comprising:
a cellular wireless network comprising a plurality of cells with base stations to provide wireless access to subscribed mobile stations, the cellular wireless network comprising a list of neighboring cells for cells in the cellular wireless network;
a private wireless network comprising one or more private cells to provide wireless access to a subset of the subscribed mobile stations in the cellular wireless network;
a mechanism to obtain mapping information between a serving cell in the cellular wireless network for a mobile station and radio cells in the private wireless network to which the mobile station is granted access;
a first handover mechanism to perform a handover from the serving cell in the cellular wireless network to another cell in the cellular wireless network based on the list of neighboring cells for cells in the cellular wireless network; and
a second handover mechanism to perform a handover from the serving cell in the cellular wireless network to a cell in the one or more private wireless networks based on the information on access to one or more private wireless networks granted to the mobile station that is being served by the cell of the cellular wireless network in the mobile station, without relying on the list of neighboring cells for cells in the cellular wireless network.

17. The system as in claim 16, comprising:
a mechanism to select radio cells in the one or more private wireless networks as candidate radio cells for handover of the mobile station from the serving cell in the cellular wireless network to one of the selected radio cells of the private wireless network;
a mechanism to applying a selection condition to select one radio cell from the candidate radio cells as a target radio cell for the handover; and
a mechanism to perform handover of the mobile station from the cellular wireless network to the selected one target radio cell.

18. A wireless communication system, comprising:
a cellular wireless network comprising a plurality of cells with base stations to provide wireless access to subscribed mobile stations, the cellular wireless network comprising a list of neighboring cells for cells in the cellular wireless network;
a private wireless network comprising one or more private cells to provide wireless access to a subset of the subscribed mobile stations in the cellular wireless network;
a mechanism to obtain mapping information between a serving cell in the cellular wireless network for a mobile station and radio cells in the private wireless network to which the mobile station is granted access; and
a mechanism to select radio cells in the one or more private wireless networks as candidate radio cells for handover of the mobile station from the serving cell in the cellular wireless network to one of the selected radio cells of the private wireless network.

19. The system as in claim 18, comprising:
a mechanism to apply a selection condition to select one radio cell from the candidate radio cells as a target radio cell for the handover; and
a mechanism to perform handover of the mobile station from the cellular wireless network to the selected one target radio cell.

20. The system as in claim 19, wherein:
the information on access to the private wireless network granted to the mobile station that is being served by the cell of the cellular wireless network comprises a list of cells in the private wireless network that are neighbors of the serving cell for the mobile station in the cellular wireless network.

21. The system as in claim 19, wherein:
the cellular wireless network comprises macrocells, and at least one of a microcell located in a macrocell, or a picocell located in a macrocell.
